(19) United States
(12) Patent Application Publication
(10) Pub. No.: US 2012/0221974 A1
(43) Pub. Date: Aug. 30, 2012

(54) METHOD AND APPARATUS FOR PRESENTING ELEMENTS OF A USER INTERFACE

(75) Inventors: Nicholas Trotta, San Francisco, CA (US); George Alfred Arriola, San Francisco, CA (US); Vince Nakayama, Los Altos, CA (US)

(73) Assignees: Sony Network Entertainment Inc., Los Angeles, CA (US); Sony Corporation, Tokyo (JP)

(21) Appl. No.: 13/036,655

(22) Filed: Feb. 28, 2011

(51) Int. Cl. G06F 3/048

(52) U.S. Cl. 715/823

(57) ABSTRACT

Methods and apparatus are provided for displaying a user interface to present a plurality of media titles. In one embodiment, method includes displaying a user interface including a plurality of graphical elements, wherein each graphical element is associated with a media title and assigned a focus state, and assigning one of the graphical elements with a selected focus state, wherein the graphical element is displayed to include a glow accent. The method may further include detecting a user command to adjust the display of the user interface, and adjusting the display of the user interface to initiate scrolling of graphical elements based on the user command, wherein adjusting the display relates to speed scrolling and the display of graphical elements is transitioned continuously to present graphical elements at an increased rate and for continuous motion across the user interface based on the user command, and wherein the selected focus state and at least one focus state of the graphical elements is updated based on the scrolling.

### CROSS REFERENCE TO RELATED APPLICATION

This application is related to commonly-assigned and concurrently filed U.S. patent application Ser. No. ______, entitled “User Interface for Presenting Graphical Elements”, the disclosure of which is hereby fully incorporated by reference.

### FIELD

The present disclosure relates generally to presentation of user interface elements, and more particularly to methods and apparatus for presenting a plurality of graphical display elements.

### BACKGROUND

Typical methods of providing a device interface are usually directed to device operation for playback of a single media file or source. Some conventional devices provide a graphical menu for selection of particular media. However, these methods and devices generally require a particular input device for user selection.

With the development of network based services, many providers of media content allow for purchase and/or renting of media. Many users desire an interface for viewing and selecting media. Conventional approaches generally provide interfaces similar to network browser applications for selecting media. However, the conventional user interfaces and devices may not be suitable for presenting a plurality of files. In many instances, users desire the ability to browse a plurality of media files for rent and/or purchase on a display device. One drawback of typical systems may be the ability to view or even navigate to a desired media title, especially when many available titles that may be accessed. Thus, there is a desire for a user interface that allows for selection and presentation of media that may be accessed using device controls. Further, there exists a need to allow for a more efficient and visually pleasing presentation of content to a user.

### BRIEF SUMMARY OF THE EMBODIMENTS

Disclosed and claimed herein are methods and apparatus for displaying a user interface by a device to present a plurality of media titles. In one embodiment, a method includes displaying, by the device, a user interface including a plurality of graphical elements, wherein each graphical element is associated with a media title and assigned a focus state, and assigning one of the graphical elements with a selected focus state, wherein the graphical element is displayed to include a glow accent. The method further includes detecting a user command, by the device, to adjust the display of the user interface, and adjusting the display of the user interface to initiate scrolling of graphical elements based on the user command, wherein adjusting the display relates to speed scrolling and the display of graphical elements is transitioned continuously to present graphical elements at an increased rate and for continuous motion across the user interface based on the user command, and wherein the selected focus state and at least one focus state of the graphical elements is updated based on the scrolling.

Other aspects, features, and techniques of the disclosure will be apparent to one skilled in the relevant art in view of the following detailed description of the embodiments.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIG. 1 depicts a graphical representation of a user interface according to one embodiment;

FIG. 2 depicts a simplified block diagram of a device according to one embodiment;

FIG. 3 depicts a process for displaying a user interface according to one embodiment;

FIG. 4 depicts a graphical representation of adjusting a display according to one or more embodiments;

FIG. 5 depicts a graphical representation of a user interface according to another embodiment;

FIGS. 6A-6B depict graphical representations of user interface focus states according to one embodiment;

FIG. 7 depicts a process for adjusting the user interface display according to one embodiment;

FIG. 8 depicts a graphical representation of adjusting the user interface display according to one embodiment;

FIG. 9 depicts a graphical representation of adjusting the user interface display according to another embodiment;

FIG. 10 depicts a graphical representation of adjusting the user interface display according to another embodiment;

FIGS. 11A-11B depict a graphical representation of anchor points according to one embodiment; and

FIG. 12 depicts a graphical representation of displaying graphical display elements according to one embodiment.

### DETAILED DESCRIPTION OF THE EXEMPLARY EMBODIMENTS

### Overview and Terminology

One aspect of the present disclosure relates to displaying a user interface to present a plurality of media titles. Accordingly, a device and methods are provided for display of a plurality of graphical display elements. Display of the graphical elements may be based on one or more focus states to allow for a visually pleasing display of elements and identifying selection of an element. In one embodiment, a process is provided which includes assigning a graphical element a selected focus state to allow a user to navigate a plurality of displayed graphical elements. The process may include adjusting the display of a user interface based on a detected user command. For example, adjustment of the display may relate to a focus transition, wherein a selected focus state may be applied to another graphical display element. According to another embodiment, adjustment may relate to scrolling the display of graphical elements to allow for user viewing of the display elements. For example, the user interface may allow for a user to view media content by one or more of slow scrolling, fast scrolling and group scrolling. As will be discussed in more detail below, scrolling may provide for a continuous transition of display elements. Group scrolling, for example, may be provided by initiating scrolling at a first rate and increasing the rate that graphical elements are presented to an increased rate wherein the display transitions the graphical elements to navigate to one or more sections of media titles. In certain embodiments, spotlight treatment and adjustment of display elements while navigating content may additionally be provided.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment of the present disclosure. Thus, the appearances of such phrases in various places throughout this specification are not necessarily all referring to the same embodiment. Furthermore, the particular features, structures, or characteristics may be combined in any suitable manner in one or more embodiments without limitation.

In accordance with the practices of persons skilled in the art of computer programming, the disclosure is described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the disclosure are essentially the code segments to perform the necessary tasks. The code segments can be stored in a processor readable medium, which may include any medium that can store or transfer information. Examples of the processor readable mediums include an electronic circuit, a semiconductor memory device, a read-only memory (ROM), a flash memory or other non-volatile memory, a floppy diskette, a CD-ROM, an optical disk, a hard disk, etc.

### Exemplary Embodiments

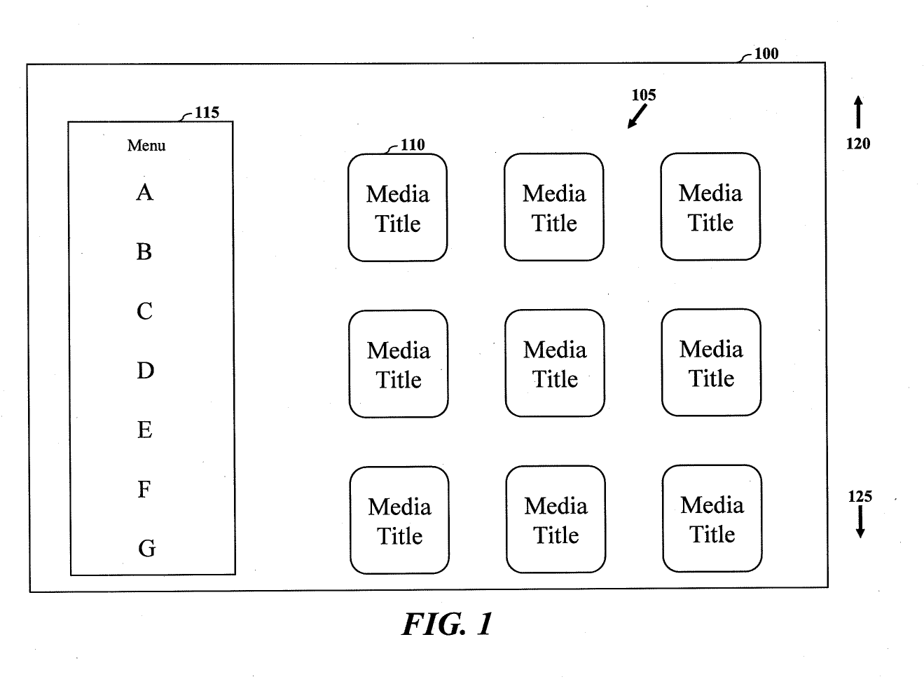

Referring now to the figures, FIG. 1 depicts a graphical representation of a user interface according to one embodiment. As depicted, user interface 100 includes a plurality of graphical elements shown as 105. In particular, user interface 100 may display one or more graphical display elements to present a plurality of media titles. Graphical elements 105 may relate to a subset of media titles which may be presented to a user. It should also be appreciated that additional, or fewer, media titles may be displayed by user interface 100. Media title 110, for example, may relate to a graphical image, video, animation, and/or text associated with a media file. By way of further example, when media presented by user interface 100 relates to movie titles, media title 110 may be displayed as cover art for a particular movie title. Media titles displayed by user interface 100 may relate to one or more of movie titles, video content, broadcast media (e.g., television series) audio files, etc. When media presented by user interface 100 relates to an audio title, media titles may be displayed as cover art, lyrical text, and/or video data associated with the title. It should also be appreciated that media titles presented by user interface 100 may not be limited to a single type of media title

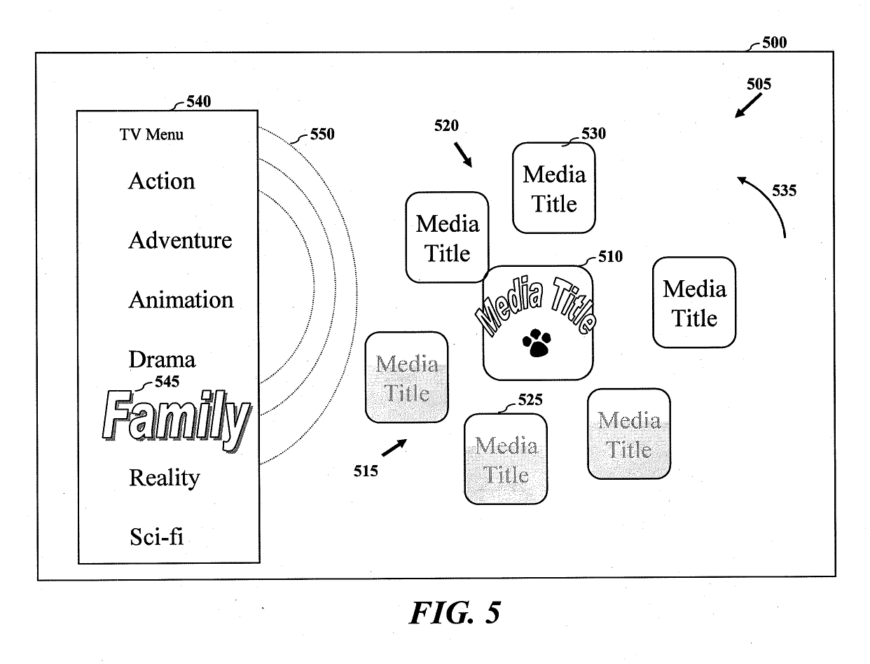

In certain embodiments, user interface 100 may include menu 115. Menu 115 may relate to a listing that a user may select to display one or more media titles. For example, as depicted in FIG. 1, elements (e.g., letters, characters, titles, keywords, etc.) may be displayed by menu 115 and may be selected by a user to view titles based on alphabetical order. When arranged in a hierarchical structure related to alphabetical order, user interface 100 can display media titles associated with the element selected. Presentation of media titles may be based on spatial organizational relationships and visual cues (e.g., focus, fade, highlighting, glow, etc.) to inform a user of relevance and to create relationships for a plurality of content types. As will be discussed in more detail below with reference to FIG. 5, media titles may alternatively be displayed based on a category.

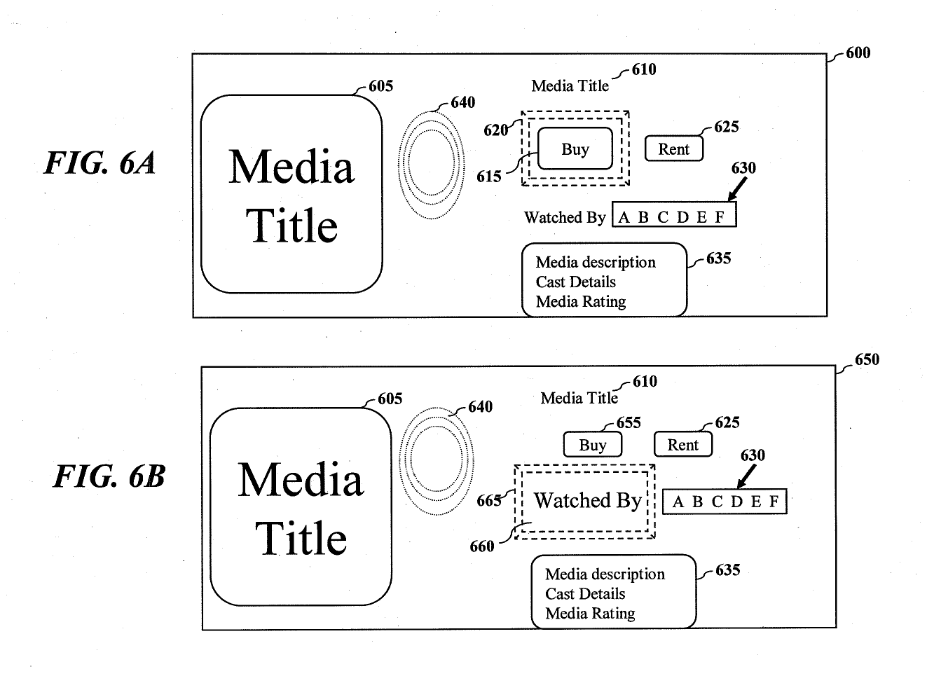

According to one embodiment, media titles 105 are depicted in a formation associated with a grid unit. Media titles may be arranged in a hierarchical arrangement, wherein a user may scroll, as shown by direction arrows 120 and 125. Arrangement of media titles in a hierarchical arrangement may be based on categorizations of featured or recommended content and then based on menu categorizations. In that fashion, media titles 105 may relate to a subset of media titles which may be presented to a user. By displaying a subset of the media titles available, a user may be presented with a manageable set of titles. As will be discussed in more detail below with respect to FIG. 5, media titles may alternatively be displayed in one of a sustainably helical or arbitrary manifold arrangement in some instances. In another embodiment, user interface 100 may be configured to transition the display of content relative to one or more formations, including a transition to graphical elements in a spiral arrangement as discussed in FIG. 5, and transition to a detailed view of a media title as discussed in FIGS. 6A-6B.

Although user interface 100 is described above with reference to media titles, it should be appreciated that the user interface may be employed for graphical display and/or presentation of different types of elements including but not limited to account management files, personnel files, data folders, calendar entries, contacts, etc. Similarly, the user interface may be employed for presentation of real-time messages, such as RSS (Really Simple Syndication) feeds.

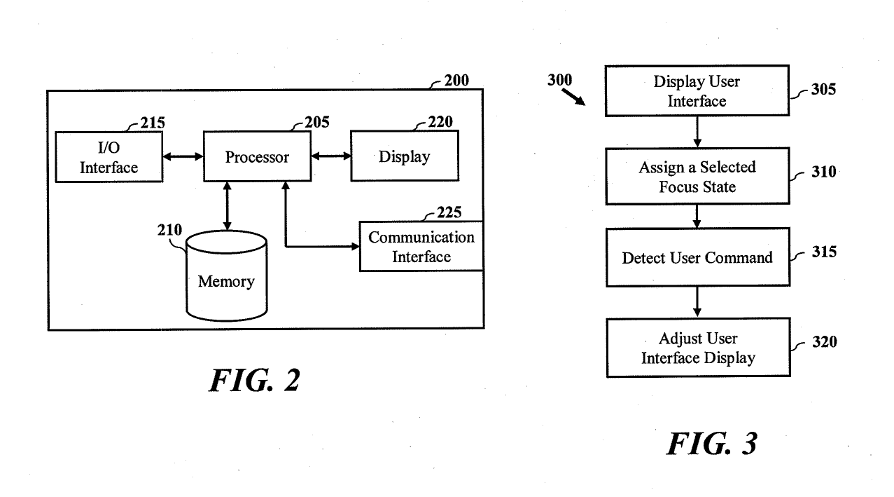

Referring now to FIG. 2, a simplified block diagram is depicted of a device according to one embodiment. In one embodiment, device 200 may be configured to provide a user interface to present a plurality of media titles. Device 200 may relate to a display device such as a television display for viewing media. It may also be appreciated that device 200 may relate to one or more devices configured to provide data to a display device such as, a set-top box, gaming console, media player (e.g., DVD, Blu-ray™, audio player, etc.), network based communication device, etc. In a further embodiment, device 200 may relate to a portable electronic device including media players, personal communication devices, etc. Device 200 may be configured to employ one for more of the processes described herein to present a plurality of media titles for a user.

As shown in FIG. 2, device 200 includes processor 205, memory 210, input/output (I/O) interface 215, display 220 and network communication interface 225. Processor 205 may be configured to control operation of device 200 based on one or more computer executable instructions stored in memory 210. Memory 210 may relate to one of RAM and ROM memories and may be configured to store one or more media files, content, and computer executable instructions for operation of device 200.

I/O interface 215 may include one or more buttons for user input, such as a numerical keypad, volume control, channel control, menu controls, pointing device, track ball, mode selection buttons, and playback functionality (e.g., play, stop, pause, forward, reverse, slow motion, etc). Buttons of I/O interface 215 may include hard and soft buttons, wherein functionality of the soft buttons may be based on one or more applications running on device 200. I/O interface 215 may be employed for one or more user commands, such as scrolling or selection of a graphical element. I/O interface 215 may additionally be configured to decode one or more remote control commands for navigating a user interface. In another embodiment, device 200 may include one or more optical drives, not shown in FIG. 2, which may be configured to detect and decode one or more media files stored on a disc (e.g., CD, DVD™, Blu-ray™, etc.). Display 220 may be employed to display a user interface. In certain embodiments, display 220 may relate to a touch screen display configured to detect one or more user selections of the display. Display 220 may be optional in certain embodiments. In yet another embodiment, device 200 may be configured to detect voice gestures. For example, motion based input controllers (e.g., wands, gaming controllers, gesture recognition and pointing devices, etc.) may additionally be employed for operation of device 200.

Communication interface 225 may be configured to allow for network based communications (e.g., downloading, uploading, streaming, etc.) including but not limited to LAN, WAN, and Wi-Fi. Communication interface 225 may be configured to allow for one or more devices to communicate with device 200 via wired or wireless communication. Communication interface 225 may additionally include one or more ports for receiving data, including ports for removable memory.

Although device 200 has been described as a computing device, it should be appreciated that the principles of the embodiments may be performed by distributed computing or processing over a network. Accordingly device 200 and one or more other computing devices may be employed to perform the functions of one or more embodiments.

Referring now to FIG. 3, a process for displaying a user interface is depicted according to one embodiment. Process 300 may be performed by the device of FIG. 2 for presenting a plurality of media titles on a user interface (e.g., user interface 100). Process 300 may be initiated by displaying a user interface at block 305. In one embodiment, the user interface may include a plurality of graphical elements arranged in a formation, wherein each element (e.g., media title 110) is associated with a media title or file and a focus state. Display at block 305 may include display of the media titles in one or more of a grid formation, sustainably helical or arbitrary manifold formation.

Process 300 may continue by assigning one of the graphical elements a selected focus state at block 310. In one embodiment, graphical display elements (e.g., graphical display elements 105) may be displayed with one of four focus states. A disabled state relates to display of the graphical element, wherein the graphical element is non-selectable. A normal state relates to display of the graphical element with focus off. Display of a graphical item with focus off may relate to the graphical element displayed as partially faded. A focused state relates to display of the graphical element with focus on and including a glow accent. Display of a media title with focus on may relate to display of a graphical item without visual fading. In one embodiment, the glow accent of the focused state may be associated with a color. The selected state relates to display of a graphical display element with focus on and a glow accent associated with a color different from that of the focused state glow accent. In one embodiment, the glow accent may relate to, for example, a blue accent, while the selected item may relate to, for example, a white accent.

At block 315, the device may detect a user command to adjust the display interface. User commands may relate to a change in position of the selected graphical display element. In another embodiment, the user command may relate to a directional command, wherein the user interface is to be adjusted. For example, the user command may indicate scrolling to change the graphical elements that are displayed. The user command may be based on based on one or more of the duration held and a number of activations for a button of an input. At block 320, the device may adjust the display of the user interface. As will be discussed below in more detail, adjusting the user interface may change the focus state of one or more graphical elements. When the user command relates to a selection within a display window of the user interface, adjusting the display may relate to updating the focus state of a graphical element to a selected focus state. When the user command relates to scrolling, the user interface may initiate scrolling display to provide a continuous transition of graphical display elements at a rate based on the user command. Additionally, the selected focus state and at least one focus state of the graphical elements may be updated during scrolling.

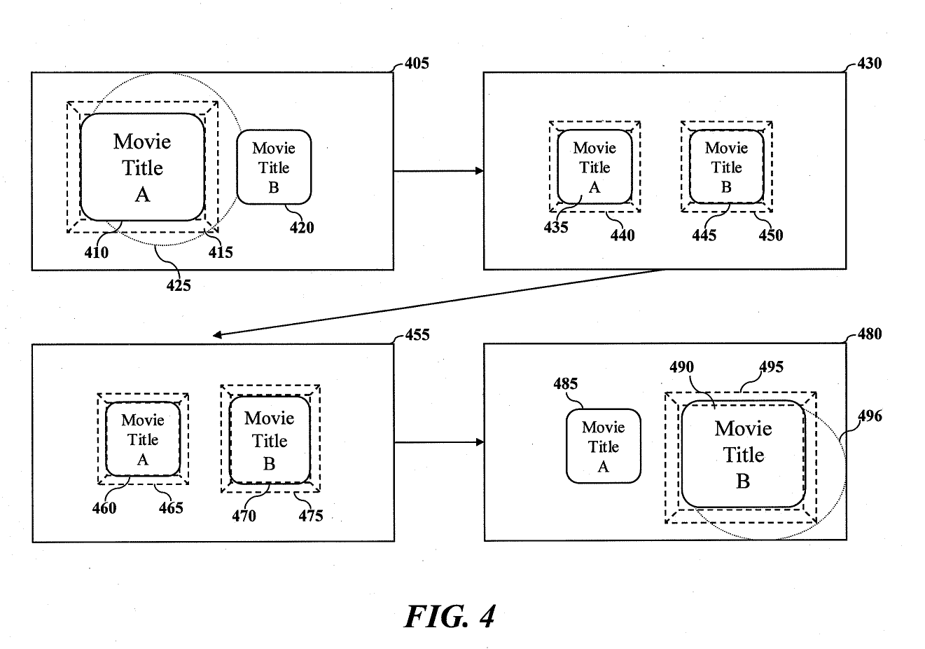

Referring now to FIG. 4, a graphical representation of adjusting a display is depicted according to one or more embodiments. According to one embodiment, display of graphical elements may include a focus state to indicate that a particular graphical display element is selected and/or highlighted. A graphical item displayed including the selected focus state may be selected by a user in order to select a particular media file or data associated with the graphical display element. The selected focus state may further be employed by a user to select one or more of the graphical display elements and for navigating a plurality of graphical display elements. According to one embodiment, a user interface may employ a focus transition when the selected focus state transitions to another graphical display element.

FIG. 4 depicts a focus transition from a first graphical display element to a second graphical display element. The user interface, shown in block 405, includes first graphical display element 410 and second graphical display element 420. Graphical element 410 is depicted in a selected state, wherein display of the element includes a glow accent shown as 415. Graphical display element 420 is depicted as in a normal state, with focus off. Display of graphical display element 410 may further be associated with spotlight effect shown as 425. The spotlight effect may relate to backlighting of the background associated with the display element, wherein the element appears to include a glow effect that radiates outward. In one embodiment, spotlight effect 425 may be provided to assist a user in identifying a selected item and smooth transition between changes in focus states.

The focus transition may be initiated at block 425. At block 425, the previously selected graphical display element, first element 435, fades to a focus state having glow accent 440. In addition, the second element 445 now includes glow accent 450. Glow accents 445 and 455 may be associated with one of a same color and different color. Alternatively, glow accents 445 and 455 may be different colors than the glow accent 415.

The focus transition may continue as shown in block 455. At block 455, first graphical display element 460 includes glow accent 465 while second graphical display element increases in size (e.g., display size) and includes glow accent 475. Glow accent 475 may include one or more of a continuous and pulsating backlit glow to appear as emanating from the graphical display item. The second element may be increased in size to emphasize the selected focus state. The transition may be completed at block 485, wherein the first graphical display element is depicted in a normal state, shown as 485, and second graphical display element 490 includes glow accent 495 and spotlight 496. The focus transition of FIG. 4 may be performed to provide a visual sense that the selection is moving between items and facilitate user viewing enjoyment of a selection area.

Referring now to FIG. 5, a graphical representation of a user interface is depicted according to another embodiment. User interface 500 may be configured to display graphical display elements in a spiral arrangement, shown as 505. The display of graphical elements in an arrangement may be based on a user selection of user interface 500. The spiral arrangement includes a first graphical display element, shown by 510, displayed in a central position within spirally arranged graphical display elements. The spiral arrangement may include a plurality of graphical display elements shown as 515 with a focus state and a second group of graphical display elements shown by 520 with a second focus state. By way of example, graphical display element 525 associated with first group 515, may include a normal state wherein focus is off Media title 530 associated with second group 520, however, may be displayed with a focused state wherein focus is on. User interface 500 may provide a rotating display of graphical display element 505 wherein elements of groups 515 and 520 may rotate as shown by direction 535. User interface 500 may present an animation of graphical display elements, wherein elements related to the first display element 510 appear to be actively added while being viewed. In certain embodiments, user interface 500 may present one or more media titles to appear as a three-dimensional presentation expressing a notion of depth and/or weight of the graphical display elements.

In one embodiment, the graphical display formation may be based on a selection of menu 540. For example, user selection of a menu category, such as family category 545, may result in display of particular media titles associated with the category. Further the user interface may display category 545 with particular display attributes. User interface 500 may also include spotlight shown as 550.

According to another embodiment, a user interface may provide detailed information and one or more functions of a selected media title when selected by a user. Further, the user interface may employ a focus transition of graphical display elements to aid in user navigation. Referring now to FIGS. 6A-6B, graphical representations of user interface focus states are depicted according to one or more embodiments. Referring first to FIG. 6A, user interface 600 includes a graphical display of a media title shown as 605. Graphical display 605 may relate to cover art of the media title and/or a graphical tile including text or graphics associated with the media title. User interface 600 may further display text associated with a media title shown as 610. User interface 600 may further include one or more graphical elements which may be selected and employed by a user to perform functions associated with media title 605.

Graphical display element 615 relates to a buy or purchase button which may be selected by the user to purchase media associated with title 605. Graphical display element 615 is depicted with a selected focus state to include glow accent 620. Graphical display element 625 relates to a selection button which may be selected to rent media title 625. User interface 600 may further include a plurality of icons, shown by 630, wherein each icon may be selected as a source of the media content. Icons 630 may be based on socially driven recommendations. User interface 600 further includes media data shown as 635 which may be selected by a user to obtain further information and details of media title 605. It may further be appreciated that a spotlight may be applied in FIGS. 6A-6B, depicted as 640. User interface 600 can allow a user to select different elements via directional inputs of a controller (e.g., remote controller, gaming control, etc.) and a highlight or selected focus states applied to graphical display items.

Referring now to FIG. 6B, a graphical representation is depicted of the user interface of FIG. 6A, following a focus transition. User interface 650 includes buy button 655 presenting a normal focus state. Based on a user selection or navigation to watched by button 660, the user interface now highlights watched by button 660, wherein the button is in a selected state including glow accent 665.

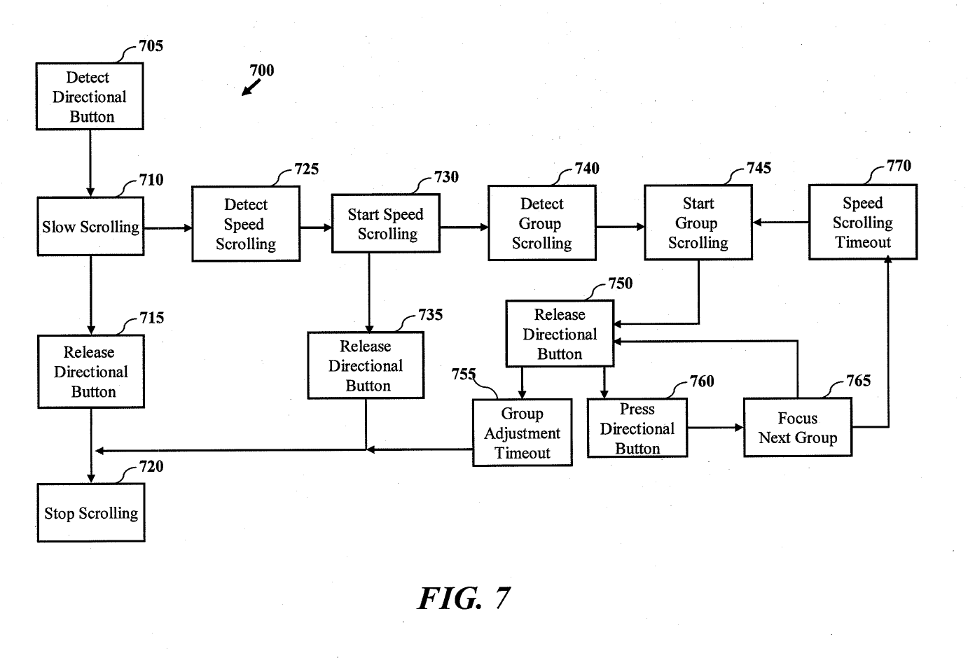

Referring now to FIG. 7, a process is depicted for adjusting the user interface display according to one embodiment. A user interface may display a subset of the media titles in a window of the user interface. The user interface may allow for a scrolling window, such that the display of other graphical display elements may be displayed. Scrolling may provide for a continuous transition of graphical display elements. In contrast to conventional methods, scrolling as described herein may allow for smoother presentation and display of graphical elements. Scrolling may relate to vertical or horizontal scrolling of the graphical display.

Process 700 may be initiated by detecting user activation of a directional button at block 705. The directional button may relate to a user pushing, activating or selecting a button on a remote control or via an input of the device. At block 710 the device may initiate slow scrolling. Slow scrolling may include applying a selected focus element to another graphical display element based on the user command and advancing the display of graphical elements in short intervals.

The device may be configured to monitor the duration of the user activation of the directional button. For a single activation or short press, the user interface may slowly scroll though graphical display elements. When the user activates the directional button for a period of time, speed scrolling may be applied. According to another embodiment, group scrolling may be provided when the user continues to activate the directional button. When the user releases the directional button after a short period of time, (e.g., 1-2 seconds), release of the direction button will be detected at block 715 and the user interface will stop scrolling at block 720.

According to one embodiment, speed scrolling will be initiated when a user activates a direction key for a particular period of time. Alternatively, or in combination, speed scrolling may be initiated by one or more of a dedicated button and series or directional button activations (e.g., activating the directional button two times in one direction). Speed scrolling may present graphical elements at an increased rate relative to slow scrolling to provide graphical elements moving continuously across the user interface. Process 700 may detect user selection of speed scrolling at block 725 and start speed scrolling at block 730. The device may be configured to detect release of a direction button at block 730 and stop speed scrolling at block 720. Speed scrolling, for example, may be provided by increasing the scrolling rate for presenting graphical display elements in comparison to slow scrolling. During speed scrolling, graphical elements may be displayed including image data associated with the media file. Further, the display of these elements may be presented in a smooth and continuous manner. In that fashion a user, may view media titles for selection while scrolling. In order to facilitate viewing of the graphical elements, focus states of the elements may be adjusted and/or improved to allow for easier viewing.

Group scrolling may be detected at block 740 when a user continues to activate a directional button. Alternatively, it may be appreciated that repeated activation, such as three activations of the directional button may initiate group scrolling. Group scrolling may be initiated at block 745. The device may be configured to detect release of a direction button at block 750. The device can detect if the user will continue to activate a directional button or activate another direction button. When a user fails to activate a directional button, the user interface can timeout the group adjustment at block 755, and stop scrolling at block 720. When the user activates a direction button, as shown by block 760, the group adjustment may adjust the focus of a next category, such as a menu category at block 765. Based on continued activation at block 765, the user interface may apply speed scrolling at block 770 and possibly group scrolling at block 745. Alternatively, the user interface may detect release of a direction button at block 750. Group scrolling may follow scrolling at a rate associated with speed scrolling and adjust the rate such that graphical elements are presented at a similar or increased rate. Further, the focus states of one or more menu items may be modified or adjusted to included a selected focus state, wherein the menu elements are highlighted and the display is advanced. The display may transition the graphical elements in a smooth and continuous fashion by adjusting the graphical elements display based on subsequent elements of the menu.

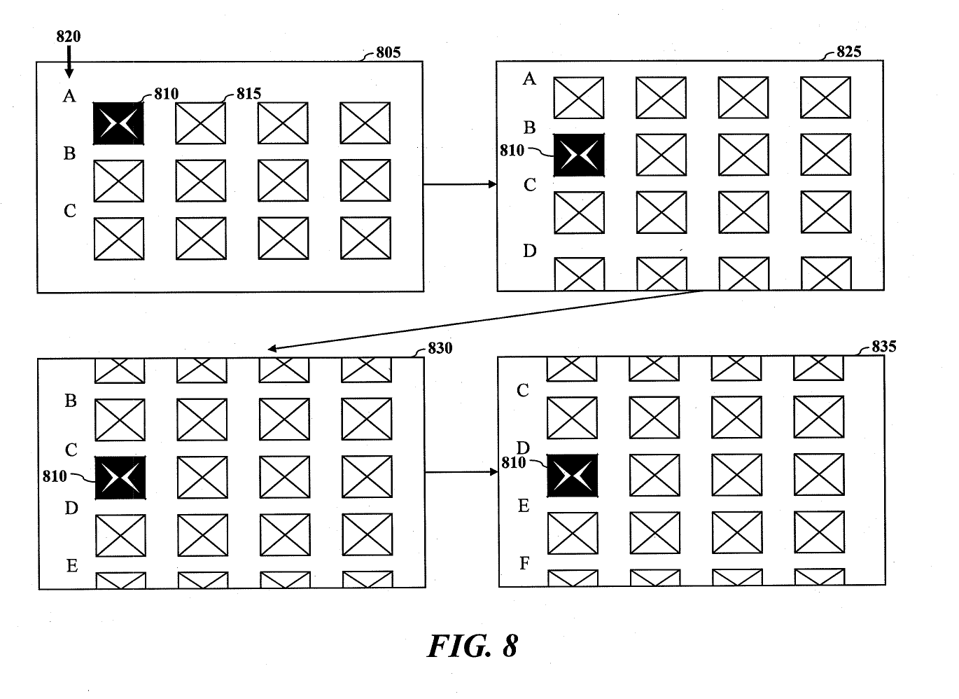

Referring now to FIG. 8, a graphical representation of adjusting the user interface display is depicted according to one embodiment. A focus state may be applied to graphical display elements to provide a user with identification of the scrolling. FIG. 8 depicts slow scrolling according to one embodiment. As shown in block 805, a focus state may be applied to a graphical display element shown as 810. The user interface may further include a plurality of non-focused display elements, such as graphical display element 815.

Slow scrolling may be presented when a user selects a directional button at block 825, wherein the selected focus state is applied to the next graphical display element based on the direction button pressed. Block 825, depicts slow scrolling in a down direction, wherein the focus state is applied to the following graphical element. In one embodiment, slow scrolling may be performed by the user interface when the user activates a direction button for a short period of time. Based on a follow up activation, block 830 may include a subsequent focus shift to the next graphical display element. Similarly, a further shift is shown in block 835.

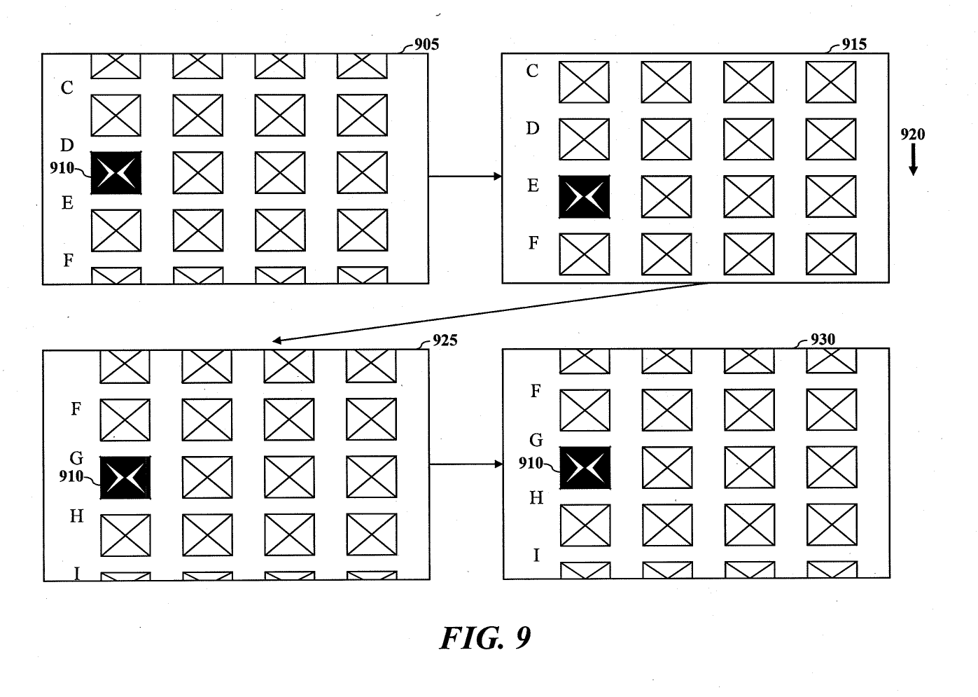

Referring now to FIG. 9, a graphical representation of adjusting the user interface display is depicted according to another embodiment. FIG. 9 depicts speed scrolling. In one embodiment, speed scrolling relates to adjusting the display of graphical elements to quickly adjust the display window of the user interface. Speed scrolling may be initiated at block 905 by detection of a user activation of a direction button. The selected state may be applied to a graphical display element and adjusted as shown in block 915 based on the user activation. The user interface continues to scroll as shown by direction 920. Block 925 depicts that speed scrolling has timed out. The user interface may adjust the graphical display elements to a menu item based on the stop. As shown in block 930 graphical display element are readjusted after the speed scrolling to a middle anchor point.

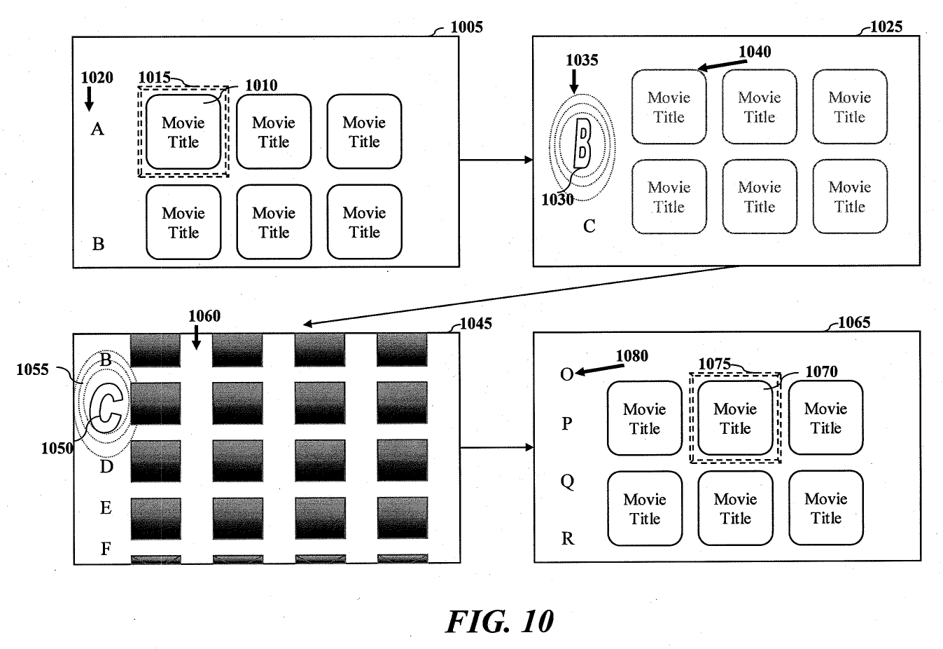

Referring now to FIG. 10, a graphical representation of adjusting the user interface display is depicted according to another embodiment. FIG. 10 depicts group scrolling. In one embodiment, group scrolling relates to advancing the display of graphical items based on a category of a display menu. For example, adjusting the display based on alphabetical arrangement of movie titles. Group scrolling may be initiated at block 1005 by detection of a user activation of a direction button. The selected focus state is applied to graphical display element 1010 including glow accent 1015. Based on user selection of a directional command, shown by 1020, group scrolling may be initiated. As shown in block 1025, group scrolling may highlight the menu category by enhancing size of a media title, shown as 1030, and applying spotlight, shown as 1035. At the initiation of group scrolling, graphical display elements may change to a focus state as shown by 1040. Group scrolling may continue at block 1045 wherein the next menu category is highlighted, as shown by 1050, and applied a spotlight accent, shown by 1055, as graphical display elements are displayed in a non-focused display state shown by 1060. When group scrolling timeout is detected, the details of the graphical elements may be displayed as shown in block 1065, wherein detail of graphical display element 1070 is restored including a glow accent 1075 indicating a selected focus state. Group scrolling may advance based on the categories. In one embodiment, block 1065 shows the selection state based on the category when group scrolling times out, as indicated by 1080.

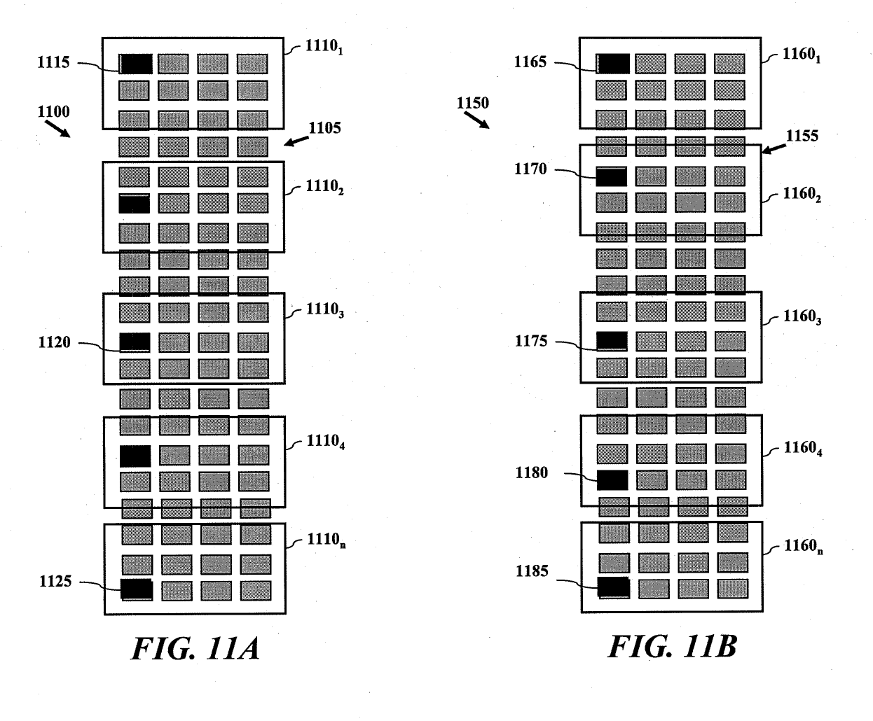

Referring now to FIGS. 11A-11B, a graphical representation of anchor points is depicted according to one embodiment. Anchor points may be employed for arranging focus based on user scrolling. One of a fixed anchor point model and a dynamic model may be employed. Referring first to FIG. 11A, a graphical representation of a fixed model is depicted. Model 1100 depicts a fixed model, wherein a pointer is vertically anchored on the display screen and moves to the screen edges only at the top and bottom of the list. For a plurality of graphical display elements 1105, windows 1110₁₋ₙ are depicted which may be displayed by the user interface. Window 1110₁ depicts a cursor anchor at the top of the window. As the user scrolls down graphical elements 1105, windows 1110₂₋₄ depict a pointer position at the center, shown by 1120, of window 1110₃. When the window reaches the bottom, the selection focus is shown as 1125. The dynamic model allows for a focus anchor to reflect the position relative a viewpoint. Windows 1160₁₋ₙ are depicted which may be displayed by the user interface. Window 1110₁ depicts a cursor anchor at the top of the window. As the user scrolls down graphical elements 1150, windows 1160₂₋₄ depict position of focus selection, as shown by 1170, 1175 and 1180. When the window reaches the bottom, the selection focus is shown as 1185

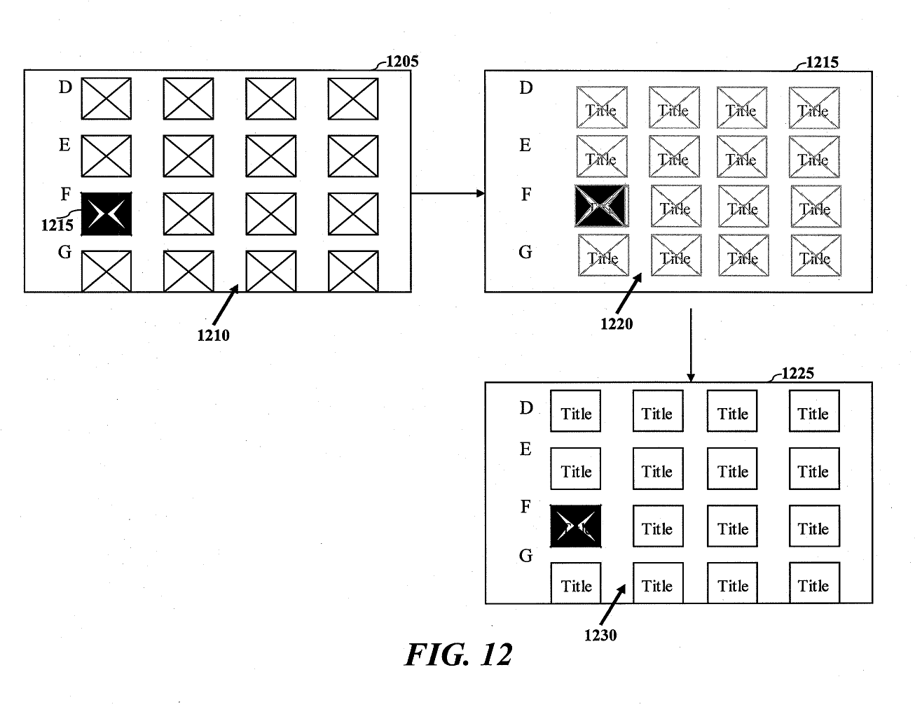

Referring now to FIG. 12, a graphical representation of focus transformation for a graphical display element is depicted according to one or more embodiments. The user interface may be configured to display cover artwork for graphical display elements. In certain instances, adjustment or navigation of the user interface may be faster than artwork may be loaded for display. Accordingly, in one embodiment, titles of the media data may be displayed. Block 1205 depicts a plurality of graphical display elements, shown as 1210. In one embodiment graphical display elements include artwork associated with a media title (e.g., cover artwork for media jacket). A focus element associated with a focus selected is depicted as 1215. When scrolling occurs, the user interface may be configured to adjust the display of graphical elements, as shown by 1220, wherein the cover artwork fades to title data. At block 1225, when scrolling is presented, only titles may be displayed.

While this disclosure has been particularly shown and described with references to exemplary embodiments thereof, it will be understood by those skilled in the art that various changes in form and details may be made therein without departing from the scope of the disclosure encompassed by the appended claims.

What is claimed is:

1. A method for displaying a user interface by a device to present a plurality of media titles, the method comprising the acts of:
displaying, by the device, a user interface including a plurality of graphical elements, wherein each graphical element is associated with a media title and assigned a focus state;
assigning one of the graphical elements with a selected focus state, wherein the graphical element is displayed to include a glow accent;
detecting a user command, by the device, to adjust the display of the user interface; and
adjusting the display of the user interface to initiate scrolling of graphical elements based on the user command,
wherein adjusting the display relates to speed scrolling and the display of graphical elements is transitioned continuously to present graphical elements at an increased rate and for continuous motion across the user interface based on the user command, and
wherein the selected focus state and at least one focus state of the graphical elements is updated based on the scrolling.

2. The method of claim 1, wherein the graphical elements are arranged in a grid formation, and each graphical element relates to one or more of a graphical display of a media title, and graphical image data associated with cover art of a media title.

3. The method of claim 1, wherein the focus state relates to one of
a disabled state, wherein the graphical element is non-selectable,
a normal state, wherein the graphical element is displayed with focus off,
a focused state, wherein the graphical element is displayed with focus on and including a glow accent associated with a first color, and
a selected state wherein the graphical element is displayed with focus on and including a glow accent associated with a second color, the second color distinct form the fist color.

4. The method of claim 1, wherein display of a graphical element with a selected focus state relates to increased display size of the graphical element and displaying one or more of a continuous and pulsating backlit glow to appear as emanating from the graphical display item.

5. The method of claim 1, wherein the user command relates to a directional command for navigating to one or more graphical elements, and wherein adjusting is based on one or more of the duration held and a number of activations for a button of an input to provide the user command.

6. The method of claim 1, wherein presentation of graphical elements associated with media titles may be based on spatial organizational relationships and visual cues for one or more of indicating relevance and creating relationships for a plurality of content types.

7. The method of claim 1, further comprising adjusting the display to initiate slow scrolling, wherein a selected focus element is applied to another graphical display element based on the user command and the display of graphical elements is advanced in short intervals.

8. The method of claim 1, further compromising adjusting the display to initiate group scrolling, wherein display of the graphical elements is advanced based on a category of a menu of the user interface, and wherein the graphical elements are displayed as blurred objects.

9. The method of claim 1, further comprising displaying a transition between the selected focus state and a following focus state, wherein a selected focus state of a graphical display element is modified to include a glow accent.

10. The method of claim 1, further comprising converting display of graphical display elements to blurred tile elements based on scrolling.

11. The method of claim 1, further comprising displaying a side menu for selection of one or more media titles associated with a menu element, wherein a menu element is displayed with a selected focus state during scrolling.

12. A computer program product stored on computer readable medium including computer executable code for displaying a user interface by a device to present a plurality of media titles, the computer program product comprising:
computer readable code to display a user interface including a plurality of graphical elements, wherein each graphical element is associated with a media title and assigned a focus state;
computer readable code to assign one of the graphical elements with a selected focus state, wherein the graphical element is displayed to include a glow accent;
computer readable code to detect a user command to adjust the display of the user interface; and
computer readable code to adjust the display of the user interface to initiate scrolling of graphical elements based on the user command,
wherein adjusting the display relates to speed scrolling and the display of graphical elements is transitioned continuously to present graphical elements at an increased rate and for continuous motion across the user interface based on the user command, and
wherein the selected focus state and at least one focus state of the graphical elements is updated based on the scrolling.

13. The computer program product of claim 12, wherein the graphical elements are arranged in a grid formation, and each graphical element relates to one or more of a graphical display of a media title, and graphical image data associated with cover art of a media title.

14. The computer program product of claim 12, wherein the focus state relates to one of
a disabled state, wherein the graphical element is non-selectable,
a normal state, wherein the graphical element is displayed with focus off,
a focused state, wherein the graphical element is displayed with focus on and including a glow accent associated with a first color, and
a selected state wherein the graphical element is displayed with focus on and including a glow accent associated with a second color, the second color distinct form the fist color.

15. The computer program product of claim 12, wherein display of a graphical element with a selected focus state relates to increased display size of the graphical element and displaying one or more of a continuous and pulsating backlit glow to appear as emanating from the graphical display item.

16. The computer program product of claim 12, wherein the user command relates to a directional command for navigating to one or more graphical elements, and wherein adjusting is based on one or more of the duration held and a number of activations for a button of an input to provide the user command.

17. The computer program product of claim 12, wherein presentation of graphical elements associated with media titles may be based on spatial organizational relationships and visual cues for one or more of indicating relevance and creating relationships for a plurality of content types.

18. The computer program product of claim 12, further comprising computer readable code to adjust the display to initiate slow scrolling, wherein a selected focus element is applied to another graphical display element based on the user command and display of graphical elements is advanced in short intervals.

19. The computer program product of claim 12, further comprising computer readable code to adjust the display to initiate group scrolling, wherein display of the graphical elements is advanced based on a category of a menu of the user interface, and wherein the graphical elements are displayed as blurred objects.

20. The computer program product of claim 12, further comprising computer readable code to display a transition between the selected focus state and a following focus state, wherein a selected focus state of a graphical display element is modified to include a glow accent.

21. The computer program product of claim 12, further comprising computer readable code to convert display of graphical display elements to blurred tile elements based on scrolling.

22. The computer program product of claim 12, further comprising computer readable code to display a side menu for selection of one or more media titles associated with a menu element, wherein a menu element is displayed with a selected focus state during scrolling.

23. A device, comprising:
a display;
a memory; and
a processor coupled to the display, and memory, the processor configured to:
display a user interface including a plurality of graphical elements, wherein each graphical element is associated with a media title and assigned a focus state;
assign one of the graphical elements with a selected focus state, wherein the graphical element is displayed to include a glow accent;
detect a user command to adjust the display of the user interface; and
adjust the display of the user interface to initiate scrolling of graphical elements based on the user command,
wherein adjusting the display relates to speed scrolling and the display of graphical elements is transitioned continuously to present graphical elements at an increased rate and for continuous motion across the user interface based on the user command, and
wherein the selected focus state and at least one focus state of the graphical elements is updated based on the scrolling.
